(19) United States
(12) Patent Application Publication
(10) Pub. No.: US 2025/0309596 A1
(43) Pub. Date: Oct. 2, 2025

(54) STRUCTURE AND RELAY STRUCTURE

(71) Applicant: Japan Aviation Electronics Industry, Limited, Tokyo (JP)

(72) Inventor: Osamu HASHIGUCHI, Tokyo (JP)

(73) Assignee: Japan Aviation Electronics Industry, Limited, Tokyo (JP)

(21) Appl. No.: 19/055,677

(22) Filed: Feb. 18, 2025

(30) Foreign Application Priority Data
Mar. 29, 2024 (JP) 2024-056896

(51) Int. Cl. H01R 25/16; H01R 4/34

(52) U.S. Cl. CPC H01R 25/162; H01R 4/34

(57) ABSTRACT

A structure comprises a fastening member, a first busbar, a second busbar and a relay structure. The second busbar is provided with a connection portion. The relay structure comprises a terminal and a housing. The housing is formed with at least one ditch. The at least one ditch extends along a first direction and is recessed in a second direction perpendicular to the first direction. The terminal has a first connecting portion, a second connecting portion and a coupling portion. The coupling portion is resiliently deformable and couples the first connecting portion with the second connecting portion. The fastening member is in a fastened state where the fastening member is fastened. Under the fastened state, one of the connection portion of the second busbar and the second connecting portion of the terminal is, at least in part, out of the at least one ditch and bites the housing.

### CROSS REFERENCE TO RELATED APPLICATIONS

This application is based on and claims priority under 35 U.S.C. § 119 to Japanese Patent Applications No. JP 2024-056896 filed Mar. 29, 2024, the contents of which are incorporated herein in their entirety by reference.

### BACKGROUND OF THE INVENTION

This invention relates to a relay structure in which busbars are connected to each other by fastening a screw to the busbars, and to a structure comprising the relay structure.

JPA 2024-4006 (Patent Document 1) discloses a structure which can mitigate misalignment between a busbar and a connecting object.

Referring to FIGS. 39 and 40, a connector 900 is provided with terminals 910 and busbar fastening portions 920. The busbar fastening portions 920 are fixed on distal ends of the terminals 910, respectively. Each of the busbar fastening portions 920 is formed with a fastening hole 922 through which a bolt 930 is fastened thereto.

A connector fastening portion 960 is connected to a busbar 950 via a Z-shaped spring 970. In detail, an end of the Z-shaped spring 970 is fixed to a nut 980, and the nut 980 is fixed to an end portion of the busbar 950. The other end of the Z-shaped spring 970 is fixed to the connector fastening portion 960. Further, the busbar 950 and the connector fastening portion 960 are connected to each other by an electrical wire 990 via the nut 980.

The connector fastening portion 960 is formed with a fastening hole 962 through which the bolt 930 is fastened thereto. The bolt 930 and the nut 940 are fastened to each other under a state where the connector fastening portion 960 overlaps with the busbar fastening portion 920, and thereby the connector fastening portion 960 is connected to the busbar fastening portion 920.

The aforementioned structure enables the Z-shaped spring 970 to mitigate misalignment between the terminal 910 of the connector 900 and the busbar 950

If the aforementioned structure is used in a highly vibrational environment, for example, the Z-shaped spring 970 and the busbar 950 connected to the Z-shaped spring 970 are vibrated and thereby noise may be generated and, for example, the Z-shaped spring 970 may be damaged.

### SUMMARY OF THE INVENTION

It is therefore an object of the present invention to provide a structure which can prevent, for example, noise generation even if the structure is used in a highly vibrational environment.

One aspect (first aspect) of the present invention provides a structure comprising a fastening member, a first busbar, a second busbar and a relay structure. The fastening member has a shaft portion. The second busbar is provided with a connection portion. The connection portion of the second busbar is provided with a hole portion. The relay structure carries out relay between the first busbar and the second busbar. The relay structure comprises a terminal and a housing. The housing holds the terminal. The housing is formed with at least one ditch. The at least one ditch extends along a first direction and is recessed in a second direction perpendicular to the first direction. The terminal has a first connecting portion, a second connecting portion and a coupling portion. The coupling portion is resiliently deformable and couples the first connecting portion with the second connecting portion. The first connecting portion is connected to the first busbar. The second connecting portion is provided with a piercing hole. The fastening member is in a fastened state where the fastening member is fastened. Under the fastened state, the shaft portion passes through both the hole portion and the piercing hole and extends in a shaft direction intersecting with both the first direction and the second direction. The second connecting portion is connected to the connection portion of the second busbar under the fastened state. Under the fastened state, one of the connection portion of the second busbar and the second connecting portion of the terminal is, at least in part, out of the at least one ditch and bites the housing.

Another aspect (second aspect) of the present invention provides a relay structure used in the structure of the first aspect. The relay structure is configured to carry out relay between a first busbar and a second busbar. The relay structure comprises a terminal and a housing. The housing holds the terminal. The housing is formed with at least one ditch. The at least one ditch extends along a first direction and is recessed in a second direction perpendicular to the first direction. The terminal has a first connecting portion, a second connecting portion and a coupling portion. The coupling portion is resiliently deformable and couples the first connecting portion with the second connecting portion. The first connecting portion is configured to be connected to the first busbar. The second connecting portion is provided with a piercing hole. The second connecting portion is configured to be connected to the second busbar. The piercing hole pierces the second connecting portion in a direction intersecting with both the first direction and the second direction.

The structure of the present invention can reduce positional variation of the connection portion of the second busbar by using the resilient deformation of the coupling portion of the terminal when the fastening member is fastened. Upon the reduction of the positional variation, the one of the connection portion of the second busbar and the second connecting portion of the terminal, which was positioned in the ditch of the housing, is, at least in part, out of the ditch and bites the housing. Accordingly, the connection portion of the second busbar and the terminal are hardly moved. Thus, even if the structure of the present invention is used in a highly vibrational environment, the structure of the present invention can prevent noise generation and can reduce possibility of damaging the second busbar and the terminal.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a structure according to a first embodiment of the present invention. In the figure, the structure is connected to third busbars.

FIG. 2 is a front view showing the structure of FIG. 1.

FIG. 3 is a cross-sectional view showing the structure of FIG. 2, taken along line A-A. In the figure, parts of the structure and the third busbar are enlarged and illustrated.

FIG. 4 is a top view showing the structure of FIG. 1.

FIG. 5 is another front view showing the structure of FIG. 1. In the figure, the structure is in the middle of being connected to the third busbars.

FIG. 6 is a cross-sectional view showing the structure of FIG. 5, taken along line B-B. In the figure, parts of the structure and the third busbar are enlarged and illustrated.

FIG. 7 is a perspective view showing a relay structure which is included in the structure of FIG. 1.

FIG. 8 is an exploded, perspective view showing the relay structure of FIG. 7.

FIG. 9 is a front view showing a housing which is included in the relay structure of FIG. 8.

FIG. 10 is a cross-sectional view showing the housing of FIG. 9, taken along line C-C.

FIG. 11 is a cross-sectional view showing the housing of FIG. 9, taken along line D-D.

FIG. 12 is a rear view showing the housing of FIG. 9.

FIG. 13 is a top view showing the housing of FIG. 9.

FIG. 14 is a bottom view showing the housing of FIG. 9.

FIG. 15 is a front view showing a terminal which is included in the relay structure of FIG. 8.

FIG. 16 is a rear view showing the terminal of FIG. 15.

FIG. 17 is a top view showing the terminal of FIG. 15.

FIG. 18 is a bottom view showing the terminal of FIG. 15.

FIG. 19 is a side view showing the terminal of FIG. 15.

FIG. 20 is a perspective view showing a structure according to a second embodiment of the present invention. In the figure, the structure is connected to third busbars.

FIG. 21 is a front view showing the structure of FIG. 20.

FIG. 22 is a cross-sectional view showing the structure of FIG. 21, taken along line E-E. In the figure, parts of the structure and the third busbar are enlarged and illustrated.

FIG. 23 is a rear view showing the structure of FIG. 20.

FIG. 24 is a top view showing the structure of FIG. 20.

FIG. 25 is another front view showing the structure of FIG. 20. In the figure, the structure is in the middle of being connected to the third busbars.

FIG. 26 is a cross-sectional view showing the structure of FIG. 25, taken along line F-F. In the figure, parts of the structure and the third busbar are enlarged and illustrated.

FIG. 27 is a rear view showing the structure of FIG. 25.

FIG. 28 is a perspective view showing a relay structure which is included in the structure of FIG. 20.

FIG. 29 is an exploded, perspective view showing the relay structure of FIG. 28.

FIG. 30 is a front view showing a housing which is included in the relay structure of FIG. 29.

FIG. 31 is a cross-sectional view showing the housing of FIG. 30, taken along line G-G.

FIG. 32 is a cross-sectional view showing the housing of FIG. 30, taken along line H-H.

FIG. 33 is a rear view showing the housing of FIG. 30.

FIG. 34 is a top view showing the housing of FIG. 30.

FIG. 35 is a top view showing a terminal which is included in the relay structure of FIG. 29.

FIG. 36 is a side view showing the terminal of FIG. 35.

FIG. 37 is a perspective view showing a second busbar which is included in the structure of FIG. 20.

FIG. 38 is another perspective view showing the second busbar of FIG. 37.

FIG. 39 is a top view showing a connector of Patent Document 1.

FIG. 40 is a side view showing the connector of FIG. 39.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First Embodiment

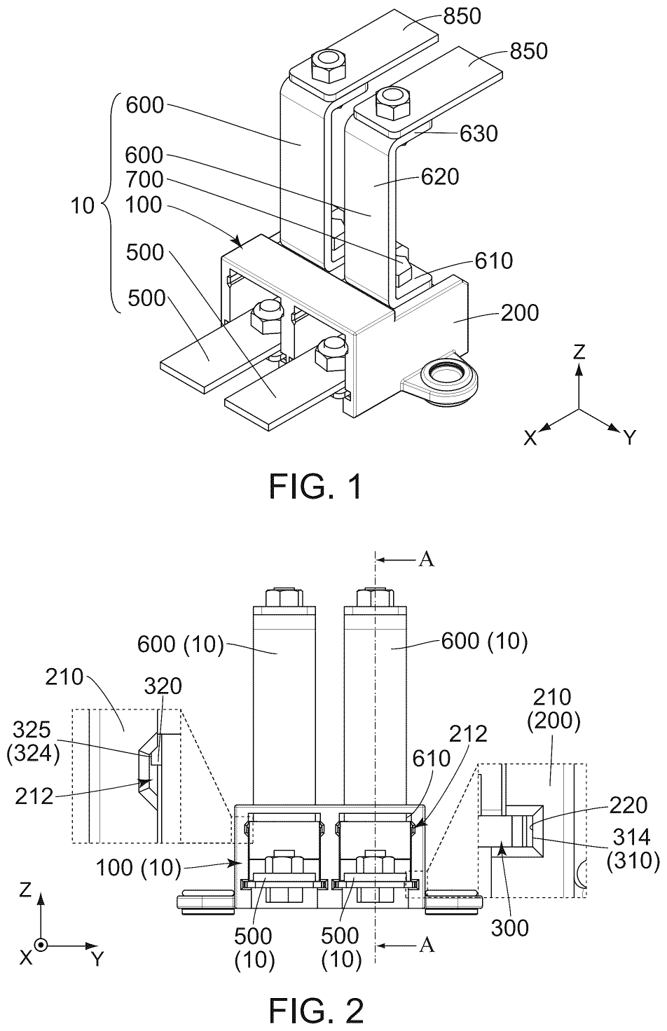

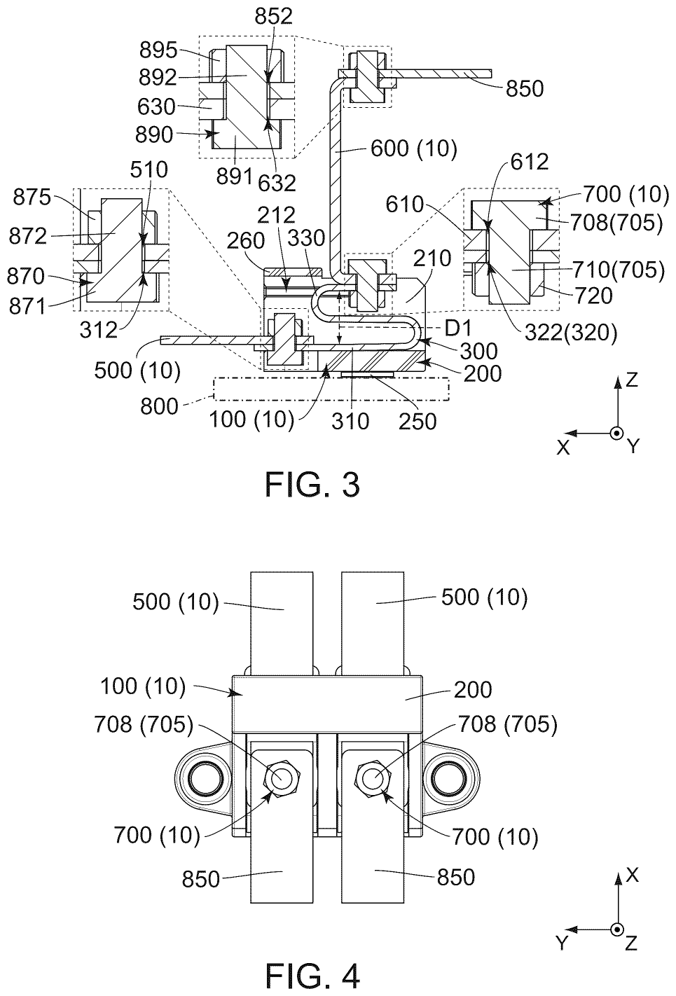

Referring to FIG. 3, a structure 10 according to a first embodiment of the present invention is configured to be attached to a housing 800. The structure 10 of the present embodiment is configured to be connected to third busbars 850 each having a piercing hole 852. As shown in FIG. 1, the structure 10 comprises fastening members 700, first busbars 500, second busbars 600 and a relay structure 100.

As shown in FIG. 3, the relay structure 100 of the present embodiment carries out relay between the first busbar 500 and the second busbar 600. As shown in FIG. 8, the relay structure 100 comprises two terminals 300 and a housing 200. However, the present invention is not limited thereto. Specifically, the number of the terminal 300 may be one. In other words, the relay structure 100 should comprise the terminal 300 and the housing 200.

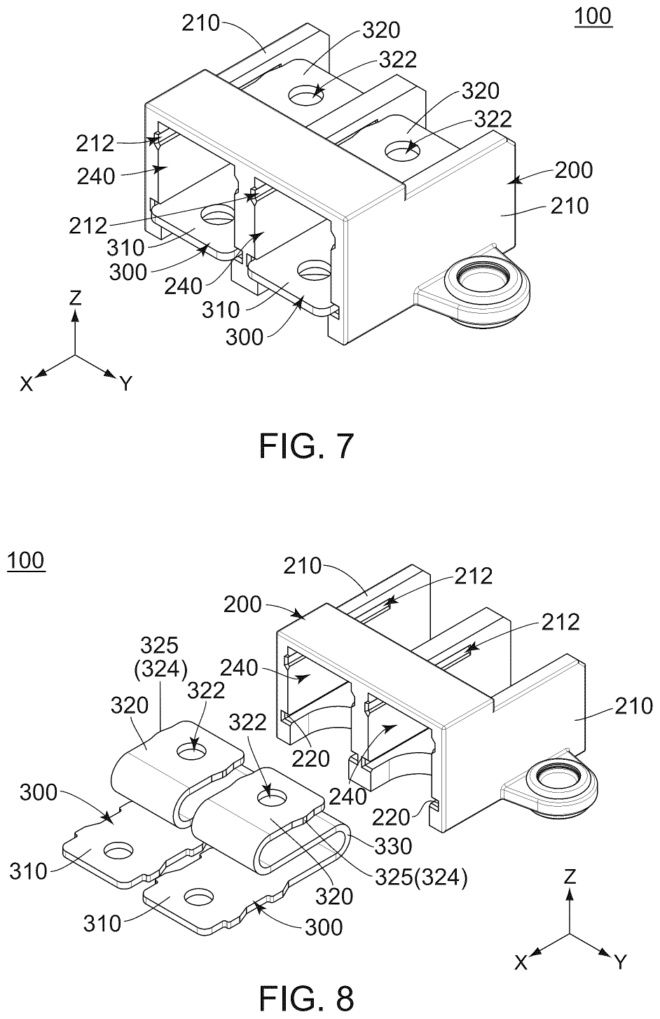

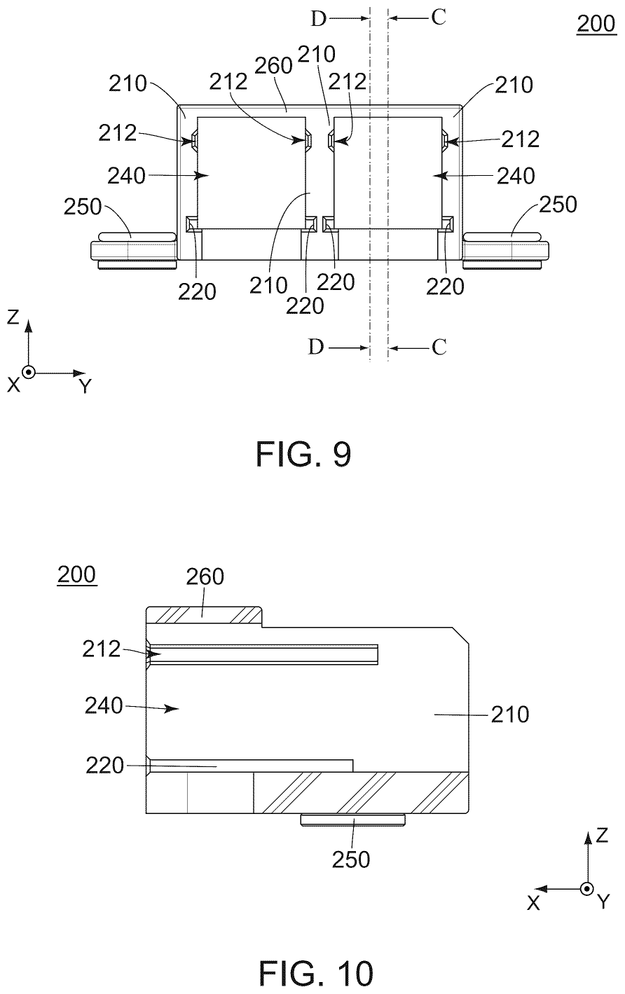

Referring to FIG. 9, the housing 200 of the present embodiment is made of insulator. As shown in FIG. 7, the housing 200 holds the terminals 300. As shown in FIG. 9, the housing 200 is formed with four ditches 212. The four ditches 212 are grouped into two pairs each consisting of two of the ditches 212. However, the present invention is not limited thereto. Specifically, the housing 200 should be formed with at least one of the ditch 212 in a case where the number of the terminal 300 is one as described above.

As shown in FIGS. 9 and 10, each of the ditches 212 extends along a first direction and is recessed in a second direction perpendicular to the first direction. Each of the ditches 212 has an opening which faces in the second direction. In the present embodiment, the first direction is an X-direction while the second direction is a Y-direction. The first direction is also referred to as a front-rear direction. Specifically, forward is a positive X-direction while rearward is a negative X-direction. Each of the ditches 212 reaches an end of the housing 200 in the first direction. Each of the ditches 212 does not reach the other end of the housing 200 in the first direction. In other words, each of the ditches 212 reaches a front end of the housing 200 in the front-rear direction, while each of the ditches 212 does not reach a rear end of the housing 200 in the front-rear direction. Each of the ditches 212 has an opening at its end in the first direction. Each of the ditches 212 is not opened at its other end in the first direction. Specifically, each of the ditches 212 has the opening at its front end, and each of the ditches 212 is not opened at its rear end. Each of the ditches 212 has a tapered shape in the second direction. Specifically, a part of each of the ditches 212 has a size in a third direction perpendicular to both the first direction and the second direction, and each of the ditches 212 has the tapered shape so that the size of the part decreases as the part travels away from the opening which faces in the second direction. In the present embodiment, the third direction is a Z-direction. Additionally, the third direction is also referred to as an up-down direction. Specifically, it is assumed that upward is a positive Z-direction while downward is a negative Z-direction. More in detail, in the two ditches 212 of each pair, one of the ditches 212, which is positioned outward of a remaining one of the ditches 212 in the second direction, has the tapered shape so that the size of the part in the third direction decreases as the part travels outward in the second direction. Additionally, the remaining one of the ditches 212, which is positioned inward of the one of the ditches 212 in the second direction, has the tapered shape so that the size of the part in the third direction decreases as the part travels inward in the second direction. However, the present invention is not limited thereto. If the housing 200 is formed with the at least one ditch 212 as described above, the at least one ditch 212 should have the tapered shape in the second direction. Alternatively, the ditch 212 may have a dovetail shape. In other words, the ditch 212 may have a tapered shape so that the size of the part in the third direction decreases as the part approaches the opening which faces in the second direction.

As shown in FIG. 9, the housing 200 has four side walls 210. The four side walls 210 are grouped into two pairs each consisting of two of the side walls 210. However, the present invention is not limited thereto. The housing 200 should have two of the side walls 210 if the number of the terminal 300 is one as described above.

Referring to FIG. 9, in the second direction, the two side walls 210 of each pair of the present embodiment are apart from each other and face each other. The four ditches 212 are formed on the four side walls 210, respectively. However, the present invention is not limited thereto. If the housing 200 has two of the ditches 212 and two of the side walls 210 as described above, the housing 200 should be configured as follows: in the second direction, the two side walls 210 are apart from each other and face each other; and the two ditches 212 are formed on the two side walls 210, respectively.

As shown in FIG. 9, the housing 200 has four press-fit portions 220. The four press-fit portions 220 are grouped into two pairs each consisting of two of the press-fit portions 220.

As shown in FIG. 9, the press-fit portions 220 of the present embodiment are provided to the side walls 210, respectively. The press-fit portion 220 is positioned below the ditch 212 in the up-down direction. The press-fit portions 220 correspond to the ditches 212, respectively. Each of the press-fit portions 220 is positioned below the corresponding ditch 212 in the up-down direction.

As shown in FIG. 9, the housing 200 has two terminal accommodating portions 240.

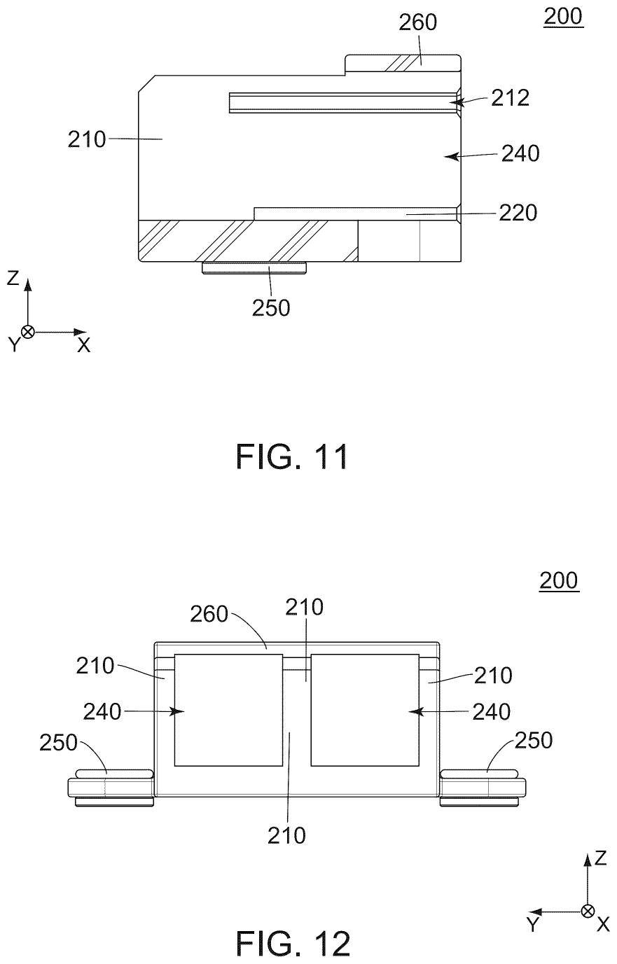

As shown in FIGS. 10 and 11, each of the terminal accommodating portions 240 of the present embodiment extends in the first direction, or in the front-rear direction. Each of the terminal accommodating portions 240 has openings at its opposite ends, respectively, in the first direction. Specifically, each of the terminal accommodating portions 240 is opened both at its front end and at its rear end in the front-rear direction. Referring to FIG. 9, the terminal accommodating portions 240 correspond to the two pairs, respectively, of the side walls 210. The terminal accommodating portions 240 correspond to the two pairs, respectively, of the ditches 212. The terminal accommodating portions 240 correspond to the two pairs, respectively, of the press-fit portions 220. Each of the ditches 212 of each pair communicates with the corresponding terminal accommodating portion 240 in the second direction. Referring to FIG. 7, the terminal accommodating portions 240 correspond to the terminals 300, respectively. Each of the terminal accommodating portions 240 accommodates the corresponding terminal 300.

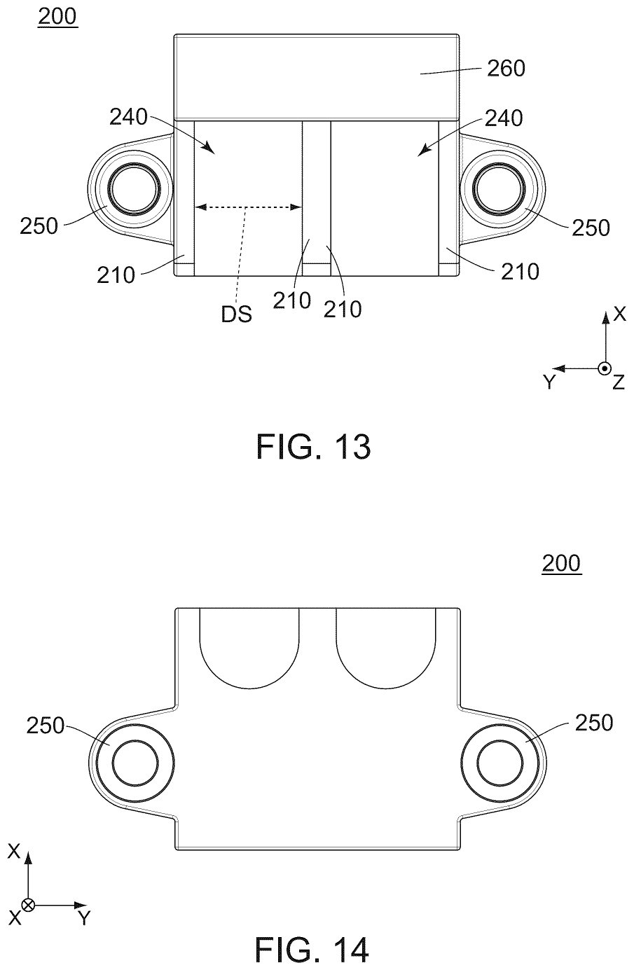

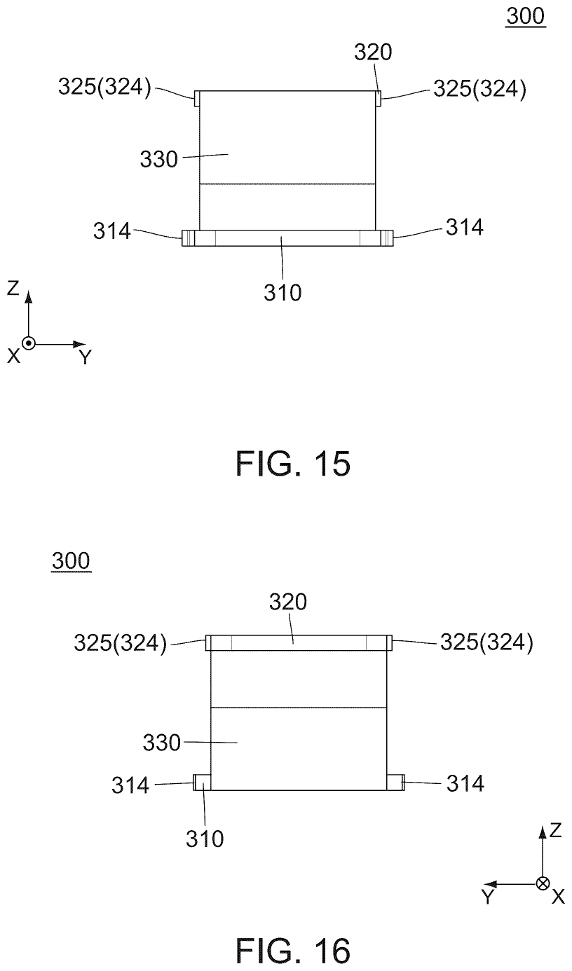

As shown in FIG. 13, the housing 200 has two fixing portions 250 and a ceiling portion 260.

As shown in FIG. 12, the fixing portions 250 of the present embodiment are positioned at opposite outer ends, respectively, of the housing 200 in the second direction. Each of the fixing portions 250 defines a lower end of the housing 200 in the up-down direction. As shown in FIG. 3, each of the fixing portions 250 is positioned below a first connecting portion 310 of the terminal 300 in the up-down direction. The structure 10 is fixed to the housing 800 by screws or the like via the fixing portions 250.

As shown in FIG. 10, the ceiling portion 260 of the present embodiment has a plate-like shape perpendicular to the third direction. The ceiling portion 260 extends rearward from a front end of the housing 200. The ceiling portion 260 defines an end of the housing 200 in the third direction. Specifically, the ceiling portion 260 defines an upper end of the housing 200 in the up-down direction. Each of the ditches 212 is positioned below the ceiling portion 260 in the up-down direction. As shown in FIG. 13, the ceiling portion 260 extends in the second direction. The ceiling portion 260 is positioned forward of any of the fixing portions 250 in the front-rear direction. As shown in FIG. 3, the ceiling portion 260 is positioned above a second connecting portion 320 of the terminal 300 in the up-down direction.

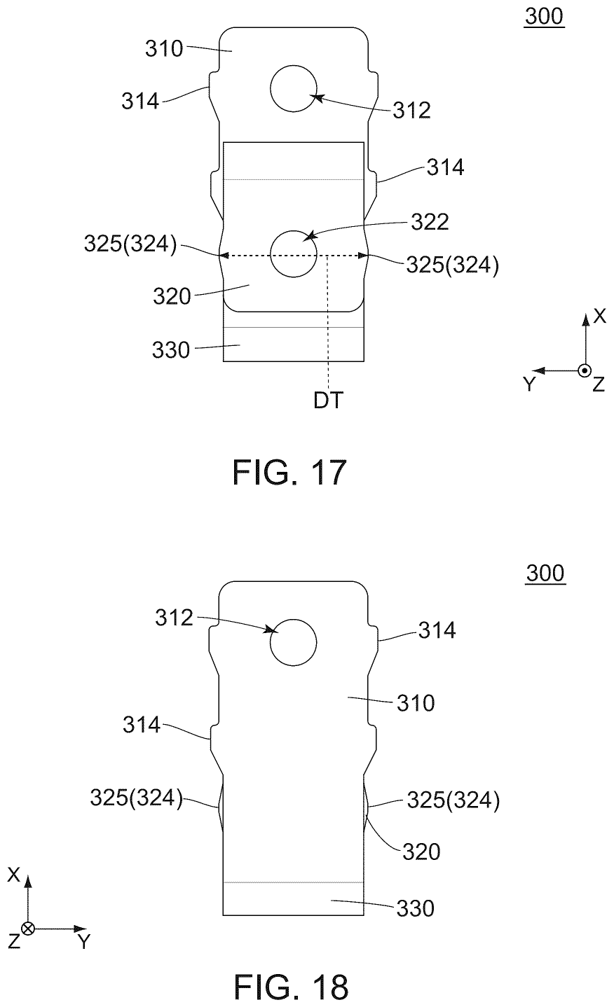

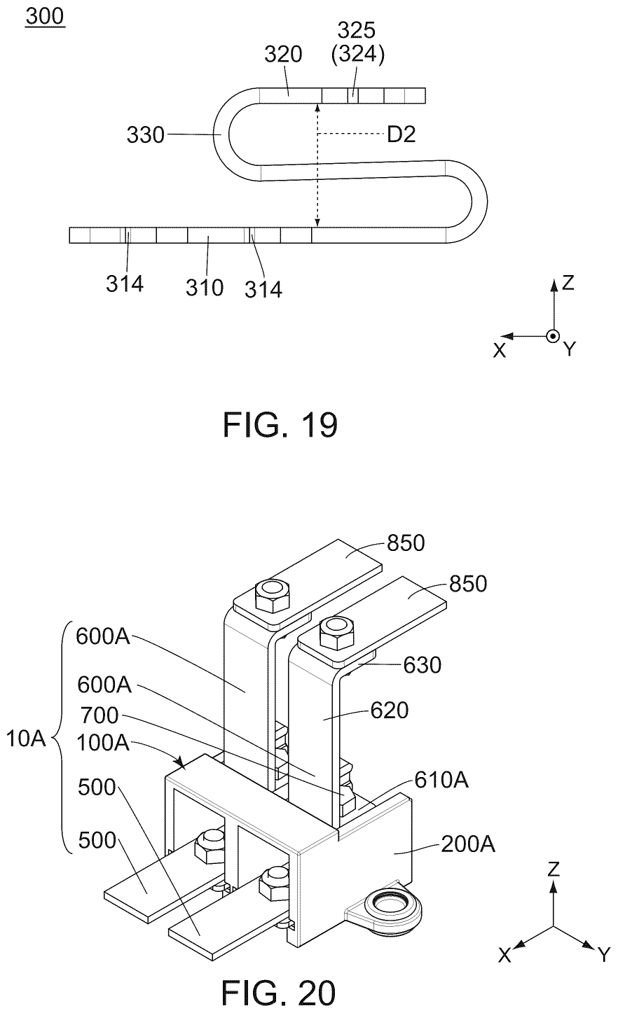

Referring to FIG. 17, each of the terminals 300 of the present embodiment is made of metal. Referring to FIG. 3, a thickness of each of the third busbars 850 is greater than a thickness of any of the terminals 300. Referring to FIG. 8, the terminals 300 correspond to the two pairs, respectively, of the side walls 210. The terminals 300 correspond to the two pairs, respectively, of the ditches 212. The terminals 300 correspond to the two pairs, respectively, of the press-fit portions 220. As shown in FIG. 19, each of the terminals 300 has the first connecting portion 310, the second connecting portion 320 and a coupling portion 330.

Referring to FIG. 18, the first connecting portion 310 of the present embodiment extends in the first direction. The first connecting portion 310 has a flat-plate shape perpendicular to the third direction. The first connecting portion 310 is provided with a piercing hole 312. The first connecting portion 310 has a plurality of press-fit protrusions 314 each protruding outward in the second direction. As shown in FIG. 2, the press-fit protrusions 314 are press-fit into the press-fit portions 220 of the housing 200. Specifically, the terminal 300 is fixed to the housing 200 by the press-fit protrusions 314 of the first connecting portion 310 being press-fit into the press-fit portions 220 of the housing 200. However, the present invention is not limited thereto. Specifically, the first connecting portion 310 may be fixed to the housing 200 by another method other than press-fitting. Alternatively, the terminal 300 may be fixed to the housing 200 as follows: the terminal 300 has a portion other than the first connecting portion 310; and the portion is fixed to the housing 200 by press-fitting or by another method.

Referring to FIG. 17, the second connecting portion 320 of the present embodiment extends in the first direction. The second connecting portion 320 has a flat-plate shape perpendicular to the third direction. The second connecting portion 320 is provided with a piercing hole 322. The piercing hole 322 pierces the second connecting portion 320 in a direction intersecting with both the first direction and the second direction. As shown in FIG. 3, the second connecting portion 320 is connected to the second busbar 600.

Referring to FIG. 2, opposite ends 325 of the second connecting portion 320 in the second direction are partially positioned in the two ditches 212, respectively. Specifically, referring to FIGS. 2 and 3, the opposite ends 325 of the second connecting portion 320 in the second direction are partially positioned in the two ditches 212, respectively, under a state where the structure 10 attached to the housing 800 is connected to the third busbars 850. However, the present invention is not limited thereto. Specifically, the structure 10 should be configured so that at least one end 325 of the second connecting portion 320 in the second direction is partially positioned in the at least one ditch 212 of the housing 200.

As shown in FIG. 17, the second connecting portion 320 is provided with two protrusions 324 each protruding in the second direction. However, the present invention is not limited thereto, but the number of the protrusion 324 may be one. Referring to FIG. 2, the two protrusions 324 are partially positioned in the two ditches 212, respectively. Specifically, the protrusions 324 of the terminal 300 are partially positioned in the two ditches 212, respectively, of the corresponding pair under the state where the structure 10 attached to the housing 800 is connected to the third busbars 850.

Referring to FIG. 3, the coupling portion 330 has an S-shaped cross-section in a plane perpendicular to the second direction. Referring to FIG. 19, the coupling portion 330 of the present embodiment is resiliently deformable. The coupling portion 330 couples the first connecting portion 310 with the second connecting portion 320. The first connecting portion 310 is connected to an end of the coupling portion 330 in the third direction, while the second connecting portion 320 is connected to the other end of the coupling portion 330 in the third direction. Specifically, the first connecting portion 310 is connected to a lower end of the coupling portion 330 in the up-down direction, while the second connecting portion 320 is connected to an upper end of the coupling portion 330 in the up-down direction. In the front-rear direction, a front end of the coupling portion 330 is positioned rearward of a front end of the first connecting portion 310. In the front-rear direction, a rear end of the coupling portion 330 is positioned rearward of a rear end of the second connecting portion 320.

As shown in FIG. 3, each of the first busbars 500 of the present embodiment extends in the first direction. Each of the first busbars 500 has a flat-plate shape perpendicular to the third direction. A thickness of each of the first busbars 500 is greater than the thickness of any of the terminals 300. Each of the first busbars 500 is provided with a piercing hole 510. The first connecting portion 310 is connected to the first busbar 500. In other words, the first connecting portion 310 is screwed to the first busbar 500. Specifically, a shaft portion 872 of a bolt 870 is screwed into a nut 875 through the piercing holes 312, 510 and thereby the first connecting portion 310 and the first busbar 500 are sandwiched by a head portion 871 of the bolt 870 and the nut 875. However, the present invention is not limited thereto. Specifically, the first connecting portion 310 and the first busbar 500 may be connected to each other by another method other than screwing.

Referring to FIG. 1, each of the second busbars 600 of the present embodiment has an angular C-shape when viewed in the second direction. Referring to FIG. 2, the second busbars 600 correspond to the two pairs, respectively, of the side walls 210. The second busbars 600 correspond to the two pairs, respectively, of the ditches 212. As shown in FIG. 3, each of the second busbars 600 is provided with a connection portion 610. The connection portion 610 of the second busbar 600 is provided with a hole portion 612. It is noted that the connection portion 610 is provided with no protrusion. Referring to FIGS. 2 and 13, in the second direction, a distance between opposite ends of the connection portion 610 of the second busbar 600 is smaller than a distance DS between the two side walls 210 of the corresponding pair. As shown in FIG. 1, each of the second busbars 600 has a flat plate portion 620 and an additional connection portion 630. The flat plate portion 620 extends in the third direction. The connection portion 610 extends along the first direction from an end in the third direction of the flat plate portion 620. Specifically, the connection portion 610 extends rearward in the front-rear direction from a lower end of the flat plate portion 620 in the up-down direction. The additional connection portion 630 extends in the first direction from the other end of the flat plate portion 620 in the third direction. Specifically, the additional connection portion 630 extends rearward in the front-rear direction from an upper end of the flat plate portion 620 in the up-down direction. As shown in FIG. 3, the additional connection portion 630 is provided with a piercing hole 632. The second busbar 600 is configured to be connected to the third busbar 850. In other words, the second busbar 600 is configured to be screwed to the third busbar 850. Specifically, when the second busbar 600 and the third busbar 850 are connected to each other, a shaft portion 892 of a bolt 890 is screwed into a nut 895 through the piercing holes 632, 852, and thereby the additional connection portion 630 and the third busbar 850 are sandwiched by a head portion 891 of the bolt 890 and the nut 895.

As described above, the structure 10 of the present embodiment is configured so that the second connecting portion 320 of the terminal 300 is provided with the protrusions 324 each protruding in the second direction while the connection portion 610 of the second busbar 600 is provided with no protrusion. However, the present invention is not limited thereto. Specifically, a protrusion 324 may be provided not on the second connecting portion 320 of the terminal 300 but on the connection portion 610 of the second busbar 600. In other words, one of the connection portion 610 of the second busbar 600 and the second connecting portion 320 of the terminal 300 should be provided with at least one protrusion 324 which protrudes in the second direction.

As shown in FIG. 3, each of the fastening members 700 of the present embodiment consists of a bolt 705 and a nut 720. However, the present invention is not limited thereto. Specifically, the fastening member 700 may not include the nut 720, and the fastening member 700 may include a screw instead of the bolt 705. If the fastening member 700 does not include the nut 720, the piercing hole 322 of the second connecting portion 320 of the terminal 300 should be female threaded.

As shown in FIG. 3, the bolt 705 has a shaft portion 710. In other words, each of the fastening members 700 has a shaft portion 710. Each of the fastening members 700 is in a fastened state where each of the fastening members 700 is fastened. Under the fastened state, the shaft portion 710 passes through both the hole portion 612 and the piercing hole 322 and extends in a shaft direction intersecting with both the first direction and the second direction. The second connecting portion 320 is connected to the connection portion 610 of the second busbar 600 under the fastened state. Specifically, under the fastened state, the structure 10 is configured as follows: the bolt 705 is screwed into the nut 720; the shaft portion 710 of the bolt 705 passes through both the hole portion 612 and the piercing hole 322 and extends in the shaft direction intersecting with both the first direction and the second direction; and the second connecting portion 320 of the terminal 300 and the connection portion 610 of the second busbar 600 are sandwiched between a head portion 708 of the bolt 705 and the nut 720 and are fixed to each other. The ceiling portion 260 is positioned forward of any of the second busbars 600 in the front-rear direction under the fastened state.

Referring to FIG. 2, under the fastened state, the second connecting portion 320 of the terminal 300 is partially out of any of the ditches 212 and is held by the housing 200 so that the second connecting portion 320 bites the housing 200. However, the present invention is not limited thereto. Specifically, the structure 10 should be configured so that, under the fastened state, one of the connection portion 610 (see FIG. 1) of the second busbar 600 and the second connecting portion 320 of the terminal 300 is, at least in part, out of the at least one ditch 212 and is held by the housing 200 so that the one of the connection portion 610 and the second connecting portion 320 bites the housing 200.

Referring to FIG. 2, under the fastened state, the opposite ends 325 of the second connecting portion 320 of the terminal 300 in the second direction are partially out of the two ditches 212, respectively, of the corresponding pair and are held by the housing 200 so that the opposite ends 325 bite the housing 200. However, the present invention is not limited thereto. Specifically, the structure 10 should be configured so that, under the fastened state, at least one of the ends of the second connecting portion 320 of the terminal 300 in the second direction is, at least in part, out of the at least one ditch 212 and is held by the housing 200 so that the at least one end bites the housing 200. Referring to FIGS. 13 and 17, in the second direction, a distance DT between the opposite ends 325 of the second connecting portion 320 of the terminal 300 is greater than the distance DS between the two side walls 210 of the corresponding pair.

Referring to FIG. 2, under the fastened state, the structure 10 is configured as follows: the opposite ends 325 of the second connecting portion 320 of the terminal 300 in the second direction are partially out of the two ditches 212, respectively, of the corresponding pair and are partially positioned outward thereof in the shaft direction; and the opposite ends 325 are held by the housing 200 so that the opposite ends 325 bite the housing 200. More in detail, under the fastened state, the structure 10 is configured as follows: the opposite ends 325 of the second connecting portion 320 of the terminal 300 in the second direction are partially out of the two ditches 212, respectively, of the corresponding pair and are partially positioned upward thereof in the up-down direction; and the opposite ends 325 are held by the housing 200 so that the opposite ends 325 bite the housing 200.

Referring to FIG. 2, under the fastened state, the two protrusions 324 of the second connecting portion 320 of the terminal 300 are partially out of the two ditches 212, respectively, of the corresponding pair while the two protrusions 324 are held by the housing 200 so that the two protrusions 324 bite the housing 200. However, the present invention is not limited thereto. Specifically, the structure 10 should be configured so that, under the fastened state, the at least one protrusion 324 is held by the housing 200 so that the at least one protrusion 324 bites the housing 200.

Referring to FIG. 2, under the fastened state, the structure 10 is configured as follows: the two protrusions 324 of the second connecting portion 320 of the terminal 300 are partially out of the two ditches 212, respectively, of the corresponding pair and are partially positioned outward thereof in the shaft direction; and the two protrusions 324 are held by the housing 200 so that the two protrusions 324 bite the housing 200. More in detail, under the fastened state, the structure 10 is configured as follows: the two protrusions 324 of the second connecting portion 320 of the terminal 300 are partially out of the two ditches 212, respectively, of the corresponding pair and are partially positioned upward thereof in the up-down direction; and the two protrusions 324 are held by the housing 200 so that the two protrusions 324 bite the housing 200. However, the present invention is not limited thereto. Specifically, under the fastened state, the structure 10 may be configured as follow: the protrusion 324 of the second connecting portion 320 of the terminal 300 is partially out of the ditch 212 and is partially positioned downward thereof in the up-down direction; and the protrusion 324 is held by the housing 200 so that the protrusion 324 bites the housing 200.

As described above, under the fastened state, the protrusions 324 provided on the second connecting portion 320 are held by the housing 200 so that the protrusions 324 bite the housing 200. Accordingly, under the fastened state, the structure 10 of the present embodiment is configured as follows: the second connecting portion 320 has a part that bites the housing 200; the part can have volume as small as possible; and movement of the second connecting portion 320 of the terminal 300 is effectively regulated.

Although the structure 10 of the aforementioned embodiment is configured so that the second connecting portion 320 is provided with the two protrusions 324, the present invention is not limited thereto. The second connecting portion 320 of the terminal 300 may be provided with no protrusion 324, provided that, under the fastened state, at least one of the ends of the second connecting portion 320 of the terminal 300 in the second direction is held by the housing 200 so that the at least one of the ends of the second connecting portion 320 bites the housing 200. A part of the second connecting portion 320, which bites the housing 200 under the fastened state, may be any part of the second connecting portion 320, provided that the part of the second connecting portion 320 is the end of the second connecting portion 320 in the second direction.

Hereinafter, an explanation will be made about assembly of the structure 10, attachment of the structure 10 to the housing 800 and attachment of the structure 10 to the third busbars 850.

First, the first busbars 500 and the second busbars 600 are screwed to the terminals 300, respectively, of the relay structure 100. Specifically, the shaft portion 872 of the bolt 870 passes though both the piercing hole 312 of the first connecting portion 310 of the terminal 300 and the piercing hole 510 of the first busbar 500 and is screwed into the nut 875. Then, the first connecting portion 310 and the first busbar 500 are sandwiched by the head portion 871 of the bolt 870 and the nut 875, and thereby the first busbar 500 is fastened to the first connecting portion 310 of the terminal 300 of the relay structure 100. Similarly, the shaft portion 710 of the bolt 705 passes though both the piercing hole 322 of the second connecting portion 320 of the terminal 300 and the hole portion 612 of the connection portion 610 of the second busbar 600 and is screwed into the nut 720. Then, the second connecting portion 320 and the connection portion 610 of the second busbar 600 are sandwiched by the head portion 708 of the bolt 705 and the nut 720, and thereby the second busbar 600 is fastened to the second connecting portion 320 of the terminal 300 of the relay structure 100.

Next, the structure 10 is attached on the housing 800. At this time, the structure 10 is positioned below any of the third busbars 850 in the up-down direction. In this state, the protrusion 324 of the second connecting portion 320 of the terminal 300 is positioned in the ditch 212 and does not bite the housing 200.

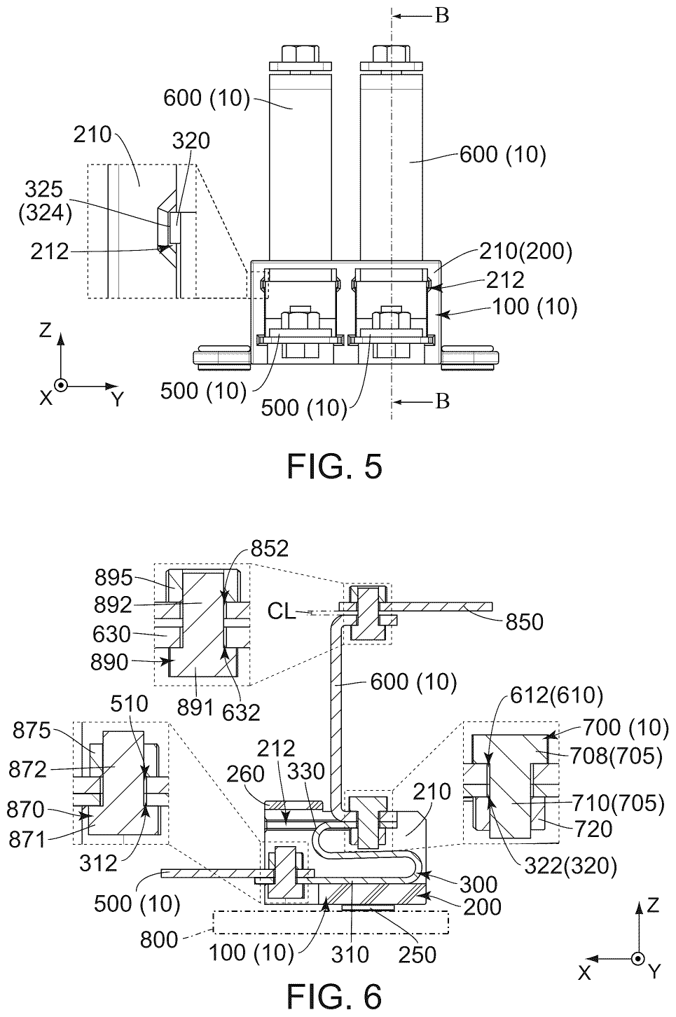

From this state, the shaft portion 892 of the bolt 890 passes through both the piercing hole 632 of the additional connection portion 630 of the second busbar 600 of the structure 10 and the piercing hole 852 of the third busbar 850 and is screwed into the nut 895. Then, the structure 10 and the third busbars 850 change their state into a state shown in each of FIGS. 5 and 6. In this state, the protrusion 324 of the second connecting portion 320 of the terminal 300 is still positioned in the ditch 212 and does not bite the housing 200. Considering tolerance of spacing between the housing 800 and the third busbar 850 and positional variation of the connection portion 610 of the second busbar 600 according to such as dimensional tolerance of the second busbar 600 in the third direction, a clearance CL is provided between the additional connection portion 630 of the second busbar 600 and the third busbar 850 in this state.

After that, the bolt 890 is further screwed into the nut 895 so that the additional connection portion 630 of the second busbar 600 and the third busbar 850 are tightly sandwiched by the head portion 891 of the bolt 890 and the nut 895. Then, each of the opposite ends 325 of the second connecting portion 320 of the terminal 300 in the second direction is partially out of the ditch 212 and bites the housing 200. That is, at this time, each of the protrusions 324 of the second connecting portion 320 of the terminal 300 is partially out of the ditch 212 and bites the housing 200. Then, the structure 10 and the third busbars 850 change their state into a state shown in each of FIGS. 2 and 3, and the assembly and attachment of the structure 10 are completed. In this state, the coupling portion 330 of the terminal 300 is resiliently deformed and thereby the terminal 300 has an increased distance between the first connecting portion 310 and the second connecting portion 320 in the third direction. Specifically, a distance D1 (see FIG. 3) is greater than a distance D2 (see FIG. 19), wherein: the structure 10, which is fixed to the housing 800, and the third busbar 850 have the distance D1 between the first connecting portion 310 and the second connecting portion 320 in the third direction after the connection of the second busbar 600 to the third busbar 850 is completed; and the terminal 300 has the distance D2 between the first connecting portion 310 and the second connecting portion 320 in the third direction when the terminal 300 is in a natural state. In this state, each of the opposite ends 325 of the second connecting portion 320 of the terminal 300 in the second direction is partially out of the ditch 212 while each of the opposite ends 325 is held by the housing 200 so that each of the opposite ends 325 bites the housing 200. Specifically, in this state, each of the protrusions 324 of the second connecting portion 320 of the terminal 300 is partially out of the ditch 212 while each of the protrusions 324 is held by the housing 200 so that each of the protrusions 324 bites the housing 200. Additionally, in this state, the additional connection portion 630 of the second busbar 600 and the third busbar 850 are brought into close contact with each other in the third direction and the clearance CL is absorbed.

As described above, the structure 10 of the present embodiment can reduce positional variation of the connection portion 610 of the second busbar 600 by using the resilient deformation of the coupling portion 330 of the terminal 300 when the structure 10 attached to the housing 800 is connected to the third busbars 850. That is, under the fastened state, the structure 10 can reduce the positional variation of the connection portion 610 of the second busbar 600 by using the resilient deformation of the coupling portion 330 of the terminal 300. As described above, upon the reduction of the positional variation, the second connecting portion 320 of the terminal 300, which was positioned in the ditch 212 of the housing 200, is partially out of the ditch 212 while the second connecting portion 320 is held by the housing 200 so that the second connecting portion 320 bites the housing 200. Accordingly, the terminal 300 is hardly moved. Thus, even if the structure 10 of the present embodiment is used in a highly vibrational environment, the structure 10 of the present embodiment can prevent noise generation and can reduce possibility of damaging the second busbars 600 and the terminals 300.

In the aforementioned attaching method, the second busbars 600 are screwed to the second connecting portions 320 of the terminals 300 of the relay structure 100 and then the second busbars 600 are screwed to the third busbars 850. However, the present invention is not limited thereto. Specifically, the order of their attachment may be modified as follows: the second busbars 600 are screwed to the third busbars 850 and then the second busbars 600 are screwed to the second connecting portions 320 of the terminals 300 of the relay structure 100. The structure 10 can also have the same effect as the aforementioned effect even if the order of their attachment is modified as described above. When the second busbar 600 is screwed to the second connecting portion 320 in this case, each of the opposite ends 325 of the second connecting portion 320 of the terminal 300 in the second direction is partially out of the ditch 212 and bites the housing 200. Specifically, when the second busbar 600 is screwed to the second connecting portion 320 in this case, each of the protrusions 324 of the second connecting portion 320 of the terminal 300 is partially out of the ditch 212 and bites the housing 200. Additionally, in this case, the second busbar 600 and the third busbar 850 may be connected to each other by another method, such as welding, other than screwing. Alternatively, the second busbar 600 and the third busbar 850 may be integrally formed with each other in this case.

In the aforementioned attaching method, the second busbars 600 are screwed to the relay structure 100 and then the relay structure 100 is attached on the housing 800. However, the present invention is not limited thereto. Specifically, the order of their attachment may be modified as follows: the relay structure 100 is attached on the housing 800 and then the second busbars 600 are screwed to the relay structure 100. The structure 10 can also have the same effect as the aforementioned effect even if the order of their attachment is modified as described above.

### Second Embodiment

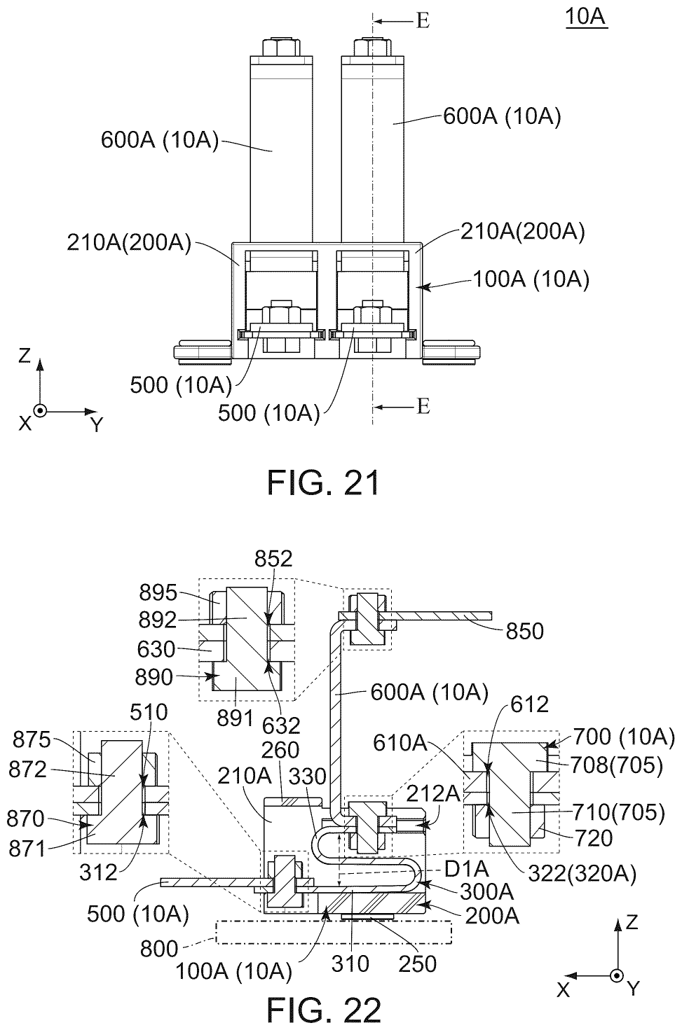

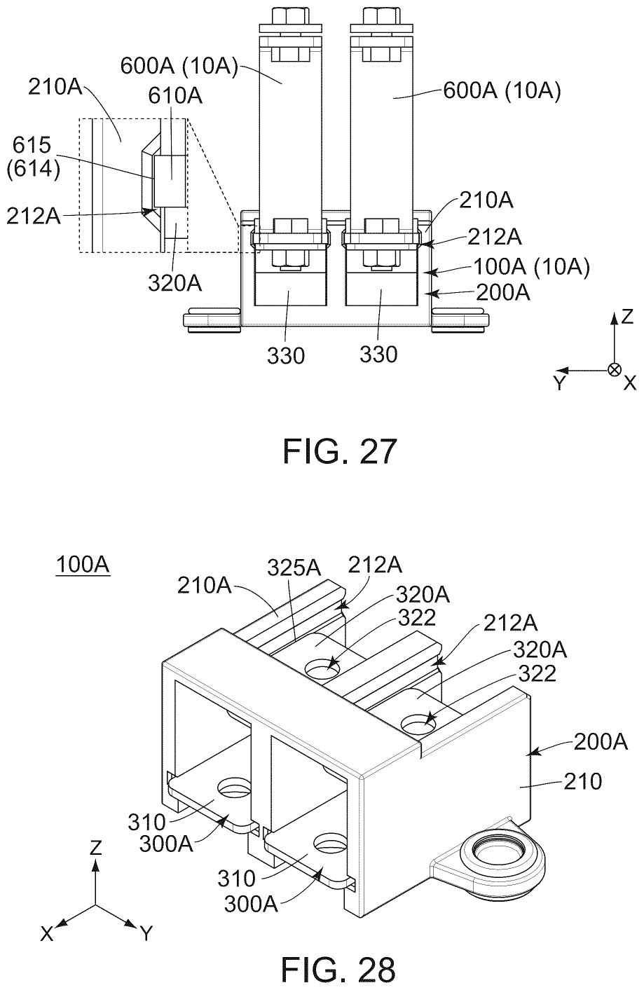

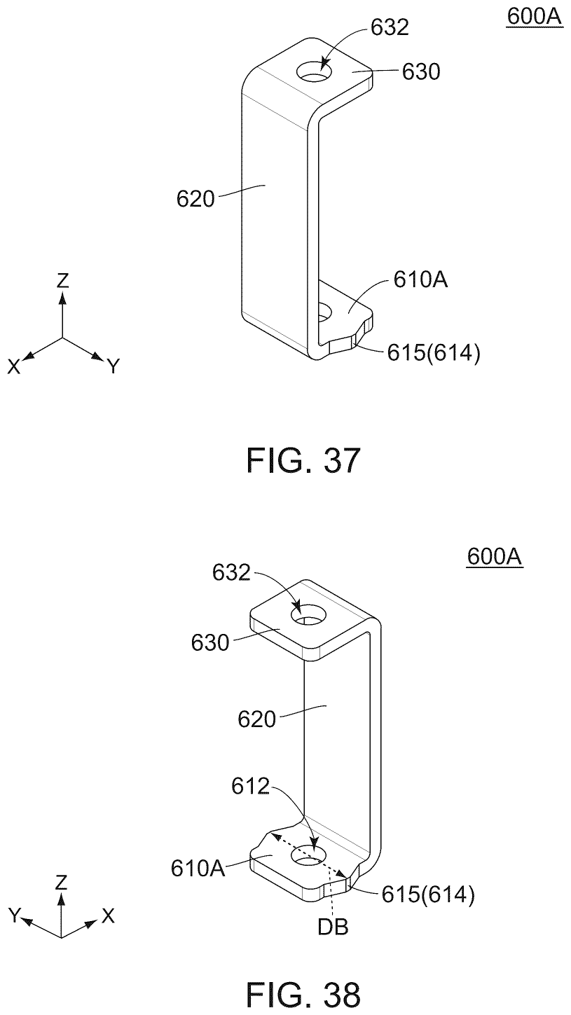

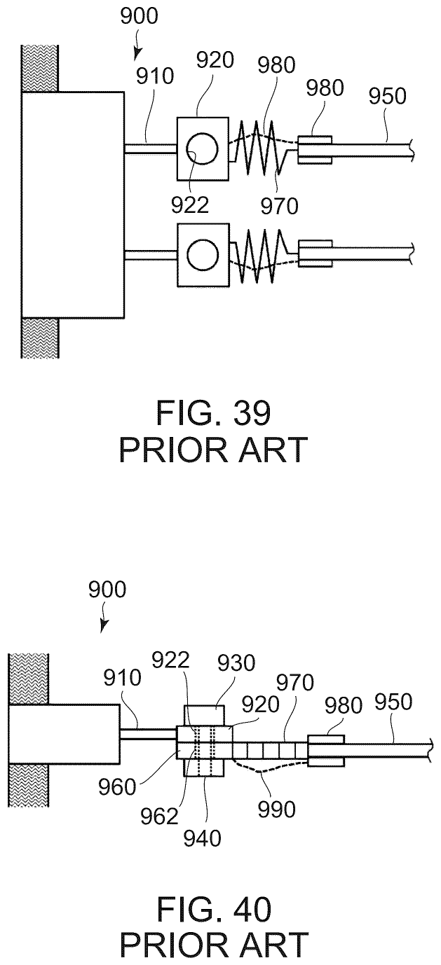

Referring to FIG. 22, a structure 10A according to a second embodiment of the present invention is configured to be attached to a housing 800. The structure 10A of the present embodiment is configured to be connected to third busbars 850 each having a piercing hole 852. The structure 10A according to the second embodiment of the present invention has a configuration similar to that of the structure 10 according to the aforementioned first embodiment as shown in FIG. 1. Components of the structure 10A shown in FIGS. 20 to 38 which are same as those of the structure 10 of the first embodiment are referred by using reference signs same as those of the structure 10 of the first embodiment. As for directions and orientations in the present embodiment, expressions same as those of the first embodiment will be used hereinbelow.

As shown in FIG. 20, the structure 10A comprises fastening members 700, first busbars 500, second busbars 600A and a relay structure 100A. The fastening member 700 and the first busbar 500 have configurations same as those of the fastening member 700 and the first busbar 500 of the first embodiment. Accordingly, a detailed explanation about the fastening member 700 and the first busbar 500 is omitted.

As shown in FIG. 22, the relay structure 100A of the present embodiment carries out relay between the first busbar 500 and the second busbar 600A. As shown in FIG. 28, the relay structure 100A comprises two terminals 300A and a housing 200A. However, the present invention is not limited thereto. Specifically, the number of the terminal 300A may be one. In other words, the relay structure 100A should comprise the terminal 300A and the housing 200A.

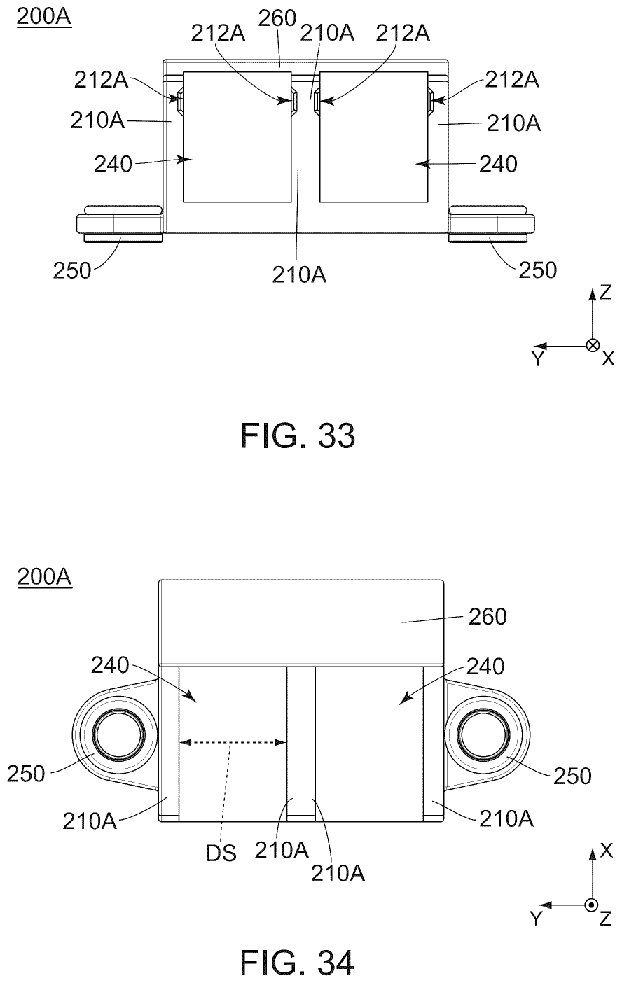

Referring to FIG. 30, the housing 200A of the present embodiment is made of insulator. As shown in FIG. 28, the housing 200A holds the terminals 300A. As shown in FIG. 33, the housing 200A is formed with four ditches 212A. The four ditches 212A are grouped into two pairs each consisting of two of the ditches 212A. However, the present invention is not limited thereto. Specifically, the housing 200A should be formed with at least one of the ditch 212A in a case where the number of the terminal 300A is one as described above.

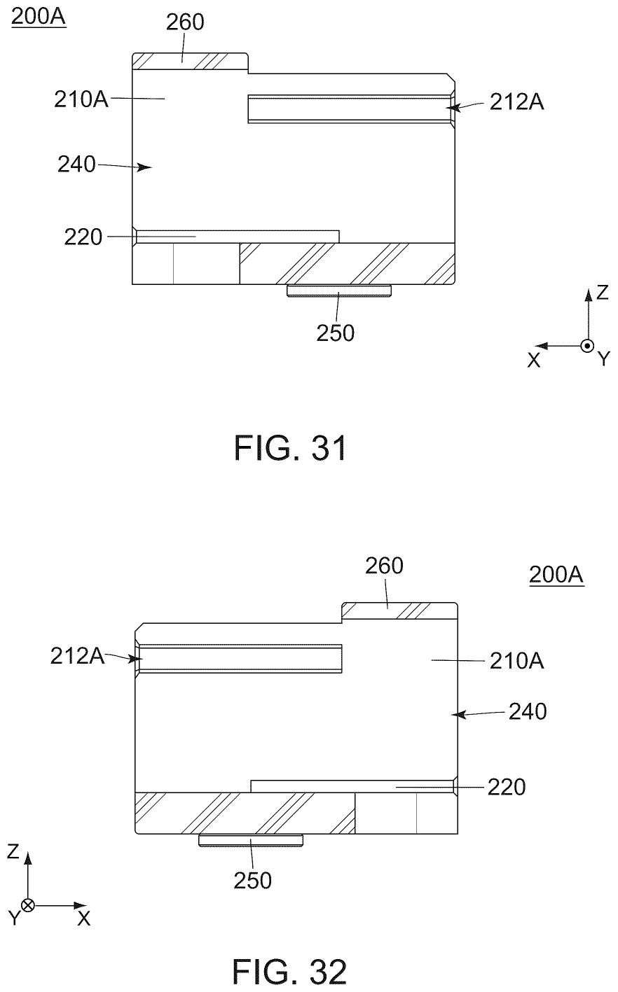

As shown in FIGS. 31 and 32, each of the ditches 212A extends along the first direction and is recessed in the second direction perpendicular to the first direction. Each of the ditches 212A has an opening which faces in the second direction. Each of the ditches 212A reaches an end of the housing 200A in the first direction. Each of the ditches 212A does not reach the other end of the housing 200A in the first direction. In other words, each of the ditches 212 reaches a rear end of the housing 200 in the front-rear direction, while each of the ditches 212 does not reach a front end of the housing 200 in the front-rear direction. Each of the ditches 212A has an opening at its end in the first direction. Each of the ditches 212A is not opened at its other end in the first direction. Specifically, each of the ditches 212 has the opening at its rear end, while each of the ditches 212 is not opened at its front end. As shown in FIG. 33, each of the ditches 212A has a tapered shape in the second direction. Specifically, a part of each of the ditches 212A has a size in the third direction, and each of the ditches 212A has the tapered shape so that the size of the part decreases as the part travels away from the opening which faces in the second direction. More in detail, in the two ditches 212A of each pair, one of the ditches 212A, which is positioned outward of a remaining one of the ditches 212A in the second direction, has the tapered shape so that the size of the part in the third direction decreases as the part travels outward in the second direction. Additionally, the remaining one of the ditches 212A, which is positioned inward of the one of the ditches 212A in the second direction, has the tapered shape so that the size of the part in the third direction decreases as the part travels inward in the second direction. However, the present invention is not limited thereto. If the housing 200A is formed with the at least one ditch 212A as described above, the at least one ditch 212A should have the tapered shape in the second direction. Alternatively, the ditch 212A may have a dovetail shape. Specifically, the ditch 212A may have a tapered shape so that the size of the part in the third direction decreases as the part approaches the opening which faces in the second direction.

As shown in FIG. 30, the housing 200A has four side walls 210A. The four side walls 210A are grouped into two pairs each consisting of two of the side walls 210A. However, the present invention is not limited thereto. The housing 200A should have two of the side walls 210A if the number of the terminal 300A is one as described above.

Referring to FIG. 33, in the second direction, the two side walls 210A of each pair of the present embodiment are apart from each other and face each other. The four ditches 212A are formed on the four side walls 210A, respectively. However, the present invention is not limited thereto. If the housing 200A has two of the ditches 212A and two of the side walls 210A, the housing 200A should be configured as follows: in the second direction, the two side walls 210A are apart from each other and face each other; and the two ditches 212A are formed on the two side walls 210A, respectively.

As shown in FIG. 30, the housing 200A has four press-fit portions 220. The four press-fit portions 220 are grouped into two pairs each consisting of two of the press-fit portions 220. The press-fit portion 220 of the present embodiment has a configuration same as that of the press-fit portion 220 of the aforementioned embodiment. Accordingly, a detailed explanation about the press-fit portion 220 is omitted.

As shown in FIG. 30, the housing 200A has two terminal accommodating portions 240, two fixing portions 250 and a ceiling portion 260. As shown in FIG. 31, each of the ditches 212A is positioned rearward of the ceiling portion 260 in the front-rear direction. The terminal accommodating portion 240, the fixing portion 250 and the ceiling portion 260 of the present embodiment have configurations same as those of the terminal accommodating portion 240, the fixing portion 250 and the ceiling portion 260 of the aforementioned embodiment. Accordingly, a detailed explanation about the terminal accommodating portion 240, the fixing portion 250 and the ceiling portion 260 is omitted.

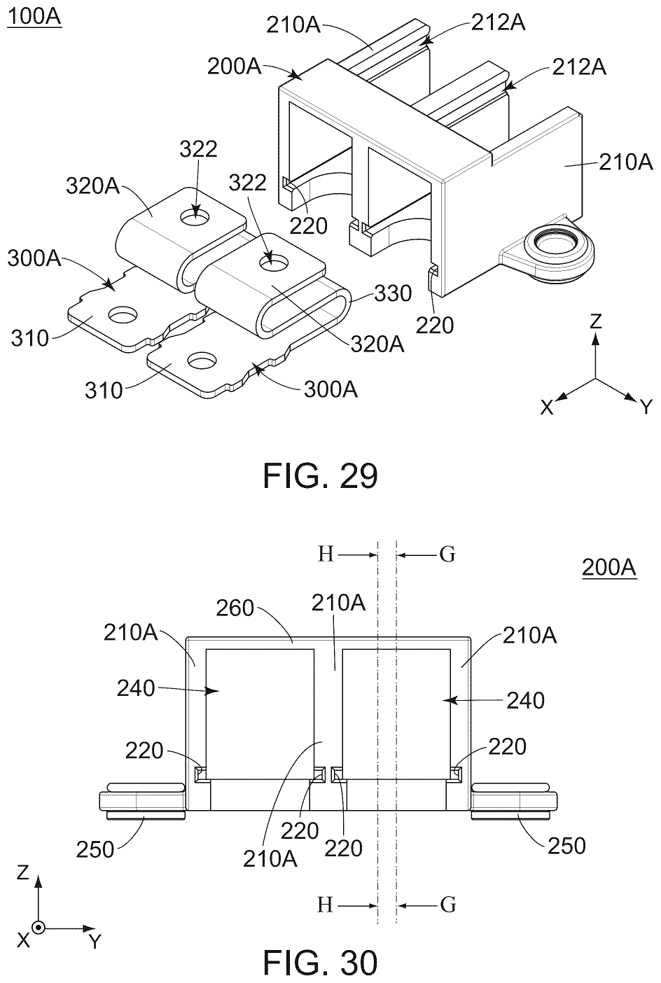

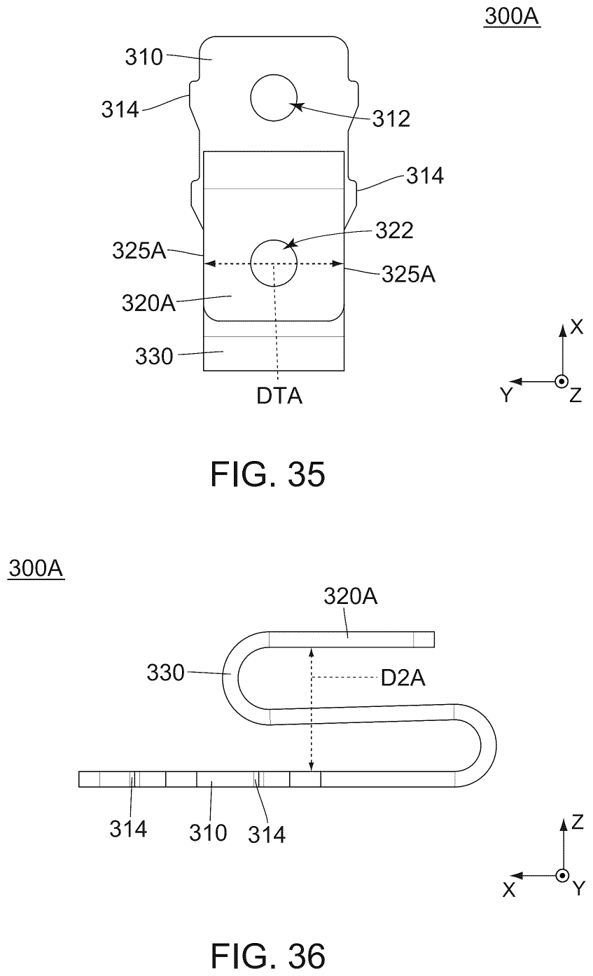

Referring to FIG. 29, each of the terminals 300A of the present embodiment is made of metal. Referring to FIG. 22, a thickness of each of the first busbars 500 is greater than the thickness of any of the terminals 300A. A thickness of each of the third busbars 850 is greater than a thickness of any of the terminals 300A. The terminals 300A correspond to the two pairs, respectively, of the side walls 210A. The terminals 300A correspond to the two pairs, respectively, of the ditches 212A. The terminals 300A correspond to the two pairs, respectively, of the press-fit portions 220. As shown in FIG. 35, each of the terminals 300A has a first connecting portion 310, a second connecting portion 320A and a coupling portion 330. The first connecting portion 310 and the coupling portion 330 of the present embodiment have configurations same as those of the first connecting portion 310 and the coupling portion 330 of the aforementioned embodiment. Accordingly, a detailed explanation about the first connecting portion 310 and the coupling portion 330 is omitted.

As shown in FIG. 35, the second connecting portion 320A of the present embodiment extends in the first direction. The second connecting portion 320A has a flat-plate shape perpendicular to the third direction. The second connecting portion 320A is provided with a piercing hole 322. The piercing hole 322 pierces the second connecting portion 320A in a direction intersecting with both the first direction and the second direction. Dissimilar to the second connecting portion 320 of the aforementioned embodiment, the second connecting portion 320A of the present embodiment is provided with no protrusion 324. As shown in FIG. 22, the second connecting portion 320A is connected to the second busbar 600A.

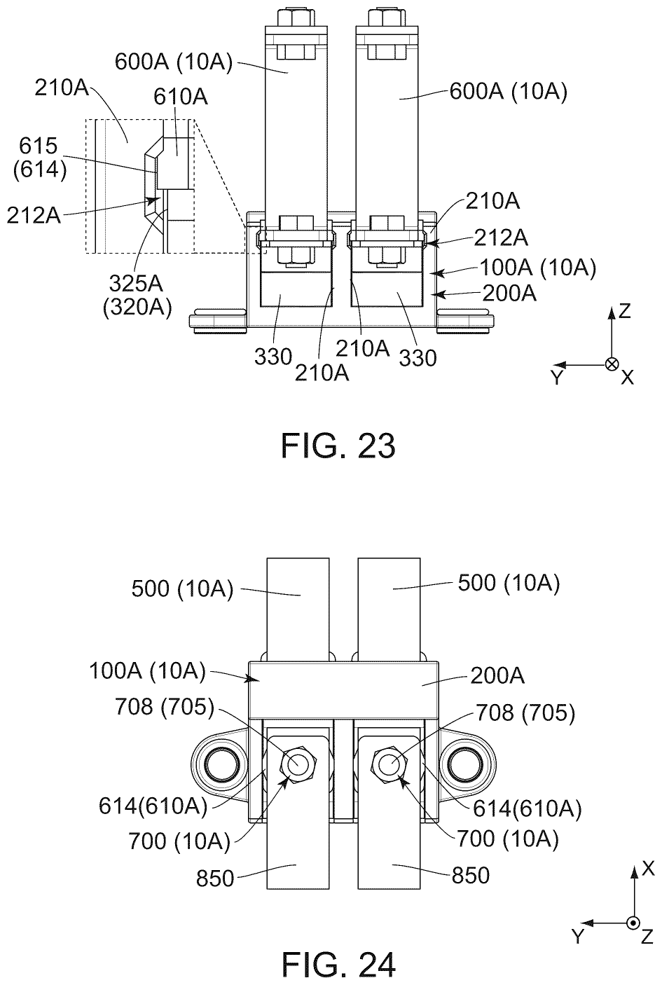

Referring to FIG. 23, the second connecting portion 320A of each of the terminal 300A has opposite ends 325A in the second direction, and the opposite ends 325A correspond to the two ditches 212A, respectively, of the corresponding pair. An outer end of the second connecting portion 320A of each of the terminals 300A in the second direction is positioned inward of the corresponding ditch 212A of the corresponding pair in the second direction under a state where the structure 10A attached to the housing 800 is connected to the third busbars 850. An inner end of the second connecting portion 320A of each of the terminals 300A in the second direction is positioned outward of the corresponding ditch 212A of the corresponding pair in the second direction under the state where the structure 10A attached to the housing 800 is connected to the third busbars 850. In other words, each of the opposite ends 325A of the second connecting portion 320A of each of the terminals 300A in the second direction is not positioned in the corresponding ditch 212A of the corresponding pair under the state where the structure 10A attached to the housing 800 is connected to the third busbars 850.

Referring to FIG. 28, the opposite ends 325A of the second connecting portion 320A in the second direction are adjacent to the two ditches 212A, respectively, in the third direction. Specifically, the opposite ends 325A of the second connecting portion 320A of each of the terminals 300A in the second direction are adjacent to the two ditches 212A, respectively, of the corresponding pair of the housing 200A in the third direction under a state where the relay structure 100A is connected to none of the second busbars 600A. In other words, the opposite ends 325A of the second connecting portion 320A of each of the terminals 300A in the second direction are adjacent to the two ditches 212A, respectively, of the corresponding pair of the housing 200A in the third direction when the relay structure 100A is viewed alone. However, the present invention is not limited thereto. Specifically, the relay structure 100A should be configured so that at least one of the ends 325A of the second connecting portion 320A of the terminal 300A in the second direction is adjacent to the at least one ditch 212A of the housing 200A in the third direction perpendicular to both the first direction and the second direction.

Referring to FIGS. 34 and 35, in the second direction, a distance DTA between the opposite ends 325A of the second connecting portion 320A of the terminal 300A is smaller than a distance DS between the two side walls 210A of the corresponding pair. Referring to FIG. 28, each of the opposite ends 325A of the second connecting portion 320A of each of the terminals 300A in the second direction is positioned below the corresponding ditch 212 A of the corresponding pair of the housing 200A in the up-down direction under the state where the relay structure 100A is connected to none of the second busbars 600A. In other words, each of the opposite ends 325A of the second connecting portion 320A of each of the terminals 300A in the second direction is positioned below the corresponding ditch 212 A of the corresponding pair of the housing 200A in the up-down direction when the relay structure 100A is viewed alone.

Referring to FIG. 20, each of the second busbars 600A of the present embodiment has an angular C-shape when viewed in the second direction. Referring to FIG. 23, the second busbars 600A correspond to the two pairs, respectively, of the side walls 210A. The second busbars 600A correspond to the two pairs, respectively, of the ditches 212A. As shown in FIG. 38, each of the second busbars 600A is provided with a connection portion 610A. The connection portion 610A is provided with two protrusions 614 each protruding in the second direction. However, the present invention is not limited thereto. Specifically, the connection portion 610A of the second busbar 600A should be provided with at least one of the protrusion 614 protruding in the second direction. The connection portion 610A of the second busbar 600A is provided with a hole portion 612. The hole portion 612 of the present embodiment has a configuration same as that of the hole portion 612 of the first embodiment. Accordingly, a detailed explanation about the hole portion 612 is omitted. The second busbar 600A has a flat plate portion 620 and an additional connection portion 630. The flat plate portion 620 and the additional connection portion 630 of the present embodiment have configurations same as those of the flat plate portion 620 and the additional connection portion 630 of the first embodiment. Accordingly, a detailed explanation about the flat plate portion 620 and the additional connection portion 630 is omitted. The connection portion 610A extends along the first direction from an end in the third direction of the flat plate portion 620. Specifically, the connection portion 610A extends rearward in the front-rear direction from a lower end of the flat plate portion 620 in the up-down direction.

As shown in FIG. 22, the second busbar 600A is configured to be connected to the third busbar 850. In other words, the second busbar 600A is configured to be screwed to the third busbar 850. Specifically, when the second busbar 600A and the third busbar 850 are connected to each other, a shaft portion 892 of a bolt 890 is screwed into a nut 895 through a piercing hole 632 and the piercing hole 852, and thereby the additional connection portion 630 and the third busbar 850 are sandwiched by a head portion 891 of the bolt 890 and the nut 895.

As shown in FIG. 22, under a fastened state where each of the fastening members 700 is fastened, the second connecting portion 320A is connected to the connection portion 610A of the second busbar 600A. Specifically, under the fastened state, the structure 10A is configured as follows: a bolt 705 is screwed into a nut 720; a shaft portion 710 of the bolt 705 passes through both the hole portion 612 and the piercing hole 322 and extends in the shaft direction intersecting with both the first direction and the second direction; and the second connecting portion 320A of the terminal 300A and the second busbar 600A are sandwiched between a head portion 708 of the bolt 705 and the nut 720 and are fixed to each other.

Referring to FIGS. 34 and 38, a distance DB between opposite ends 615 of the connection portion 610A of the second busbar 600A in the second direction is greater than a distance DS between the two side walls 210A of the corresponding pair. Referring to FIG. 23, under the fastened state, the opposite ends 615 of the connection portion 610A of the second busbar 600A in the second direction are partially out of the ditches 212A, respectively, of the corresponding pair and are held by the housing 200A so that the opposite ends 615 bite the housing 200A. However, the present invention is not limited thereto. Specifically, the structure 10A should be configured so that, under the fastened state, at least one of the ends 615 of the connection portion 610A of the second busbar 600A in the second direction is, at least in part, out of the at least one ditch 212A and is held by the housing 200A so that the at least one end 615 bites the housing 200A.

As shown in FIG. 23, under the fastened state, the opposite ends 615 of the connection portion 610A of the second busbar 600A in the second direction are partially out of the two ditches 212A, respectively, of the corresponding pair and are partially positioned outward thereof in the shaft direction while the opposite ends 615 are held by the housing 200A so that the opposite ends 615 bite the housing 200A. More in detail, under the fastened state, the opposite ends 615 of the connection portion 610A of the second busbar 600A in the second direction are partially out of the two ditches 212A, respectively, of the corresponding pair and are partially positioned upward thereof in the up-down direction while the opposite ends 615 are held by the housing 200A so that the opposite ends 615 bite the housing 200A.

As shown in FIG. 23, under the fastened state, the two protrusions 614 of the connection portion 610A of the second busbar 600A are partially out of the two ditches 212A, respectively, of the corresponding pair and are held by the housing 200A so that the two protrusions 614 bite the housing 200A. However, the present invention is not limited thereto. Specifically, the structure 10A should be configured so that, under the fastened state, the at least one protrusion 614 is held by the housing 200A so that the at least one protrusion 614 bites the housing 200A.

Referring to FIG. 23, under the fastened state, the two protrusions 614 of the connection portion 610A of the second busbar 600A are partially out of the two ditches 212A, respectively, of the corresponding pair and are partially positioned outward thereof in the shaft direction while the two protrusions 614 are held by the housing 200A so that the two protrusions 324 bite the housing 200A. More in detail, under the fastened state, the two protrusions 614 of the connection portion 610A of the second busbar 600A are partially out of the two ditches 212A, respectively, of the corresponding pair and are partially positioned upward thereof in the up-down direction while the two protrusions 614 are held by the housing 200A so that the two protrusions 614 bite the housing 200A.

As described above, under the fastened state, the protrusions 614 provided on the connection portion 610A are held by the housing 200A so that the protrusions 614 bite the housing 200A. Accordingly, under the fastened state, the structure 10A of the present embodiment is also configured as follows: the connection portion 610A has a part that bites the housing 200A; the part can have volume as small as possible; and movement of the connection portion 610A of the second busbar 600A is effectively regulated.

Although the structure 10A of the aforementioned embodiment is configured so that the connection portion 610A of the second busbar 600A is provided with the two protrusions 614, the present invention is not limited thereto. The connection portion 610A of the second busbar 600A may be provided with no protrusion 614, provided that, under the fastened state, the at least one end of connection portion 610A of the second busbar 600A in the second direction is held by the housing 200A so that the at least one end bites the housing 200A. A part of the connection portion 610A, which bites the housing 200A under the fastened state, may be any part of the connection portion 610A, provided that the part of the connection portion 610A is the end of the connection portion 610A in the second direction.

Hereinafter, an explanation will be made about assembly of the structure 10A, attachment of the structure 10A to the housing 800 and attachment of the structure 10A to the third busbars 850.

First, the first busbars 500 are screwed to the terminals 300A, respectively, of the relay structure 100A. Specifically, a shaft portion 872 of a bolt 870 passes though both a piercing hole 312 of the first connecting portion 310 of the terminal 300A and a piercing hole 510 of the first busbar 500 and is screwed into a nut 875. Then, the first connecting portion 310 and the first busbar 500 are sandwiched by a head portion 871 of the bolt 870 and the nut 875, and thereby the first busbar 500 is fastened to the first connecting portion 310 of the terminal 300A of the relay structure 100A.

Next, the connection portion 610A of the second busbar 600A is attached to the housing 200A of the relay structure 100A, and the connection portion 610A of the second busbar 600A is screwed to the second connecting portion 320A of the terminal 300A of the relay structure 100A. Specifically, the protrusion 614 of the connection portion 610A of the second busbar 600A is inserted into the ditch 212A of the housing 200A of the relay structure 100A from behind, and the second busbar 600A is moved forward relative to the relay structure 100A until the piercing hole 322 of the second connecting portion 320A of the terminal 300A and the hole portion 612 of the connection portion 610A of the second busbar 600A are positioned at positions same as each other in a plane perpendicular to the third direction. After that, the shaft portion 710 of the bolt 705 passes though both the piercing hole 322 of the second connecting portion 320A of the terminal 300A and the hole portion 612 of the connection portion 610A of the second busbar 600A and is screwed into the nut 720. Then, the second connecting portion 320A and the connection portion 610A of the second busbar 600A are sandwiched by the head portion 708 of the bolt 705 and the nut 720, and thereby the connection portion 610A of the second busbar 600A is fastened to the second connecting portion 320A of the terminal 300A of the relay structure 100A.

After that, the structure 10A is attached on the housing 800. At this time, the structure 10A is positioned below any of the third busbars 850 in the up-down direction. In this state, the protrusion 614 of the connection portion 610A of the second busbar 600A is positioned in the ditch 212A and does not bite the housing 200A.

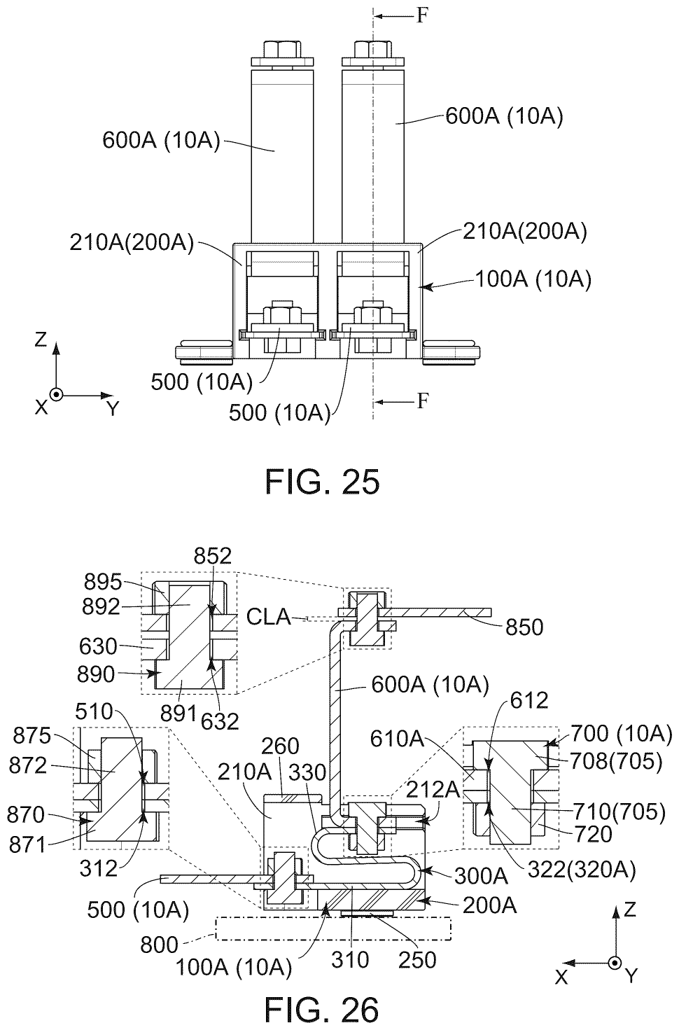

From this state, the shaft portion 892 of the bolt 890 passes through both the piercing hole 632 of the additional connection portion 630 of the second busbar 600A of the structure 10A and the piercing hole 852 of the third busbar 850 and is screwed into the nut 895. Then, the structure 10A and the third busbars 850 change their state into a state shown in each of FIGS. 25 to 27. In this state, the protrusion 614 of the connection portion 610A of the second busbar 600A is still positioned in the ditch 212A and does not bite the housing 200A. Considering tolerance of spacing between the housing 800 and the third busbar 850 and positional variation of the connection portion 610A of the second busbar 600A according to such as dimensional tolerance of the second busbar 600A in the third direction, a clearance CLA is provided between the second busbar 600A and the third busbar 850 in this state.

After that, the bolt 890 is further screwed into the nut 895 so that the additional connection portion 630 of the second busbar 600A and the third busbar 850 are tightly sandwiched by the head portion 891 of the bolt 890 and the nut 895. Then, each of the opposite ends 615 of the connection portion 610A of the second busbar 600A in the second direction is partially out of the ditch 212A and bites the housing 200A. That is, at this time, each of the protrusions 614 of the connection portion 610A of the second busbar 600A is partially out of the ditch 212A and bites the housing 200A. Then, the structure 10A and the third busbars 850 change their state into a state shown in each of FIGS. 20 and 24, and the assembly and attachment of the structure 10A are completed. In this state, the coupling portion 330 of the terminal 300A is resiliently deformed and thereby the terminal 300A has an increased distance between the first connecting portion 310 and the second connecting portion 320A in the third direction. Specifically, a distance D1A (see FIG. 22) is greater than a distance D2A (see FIG. 36), wherein: the structure 10A, which is fixed to the housing 800, and the third busbar 850 have the distance D1A between the first connecting portion 310 and the second connecting portion 320A in the third direction after the connection of the second busbar 600A to the third busbar 850 is completed; and the terminal 300A has the distance D2A between the first connecting portion 310 and the second connecting portion 320A in the third direction when the terminal 300 is in a natural state. In this state, each of the opposite ends 615 of the connection portion 610A of the second busbar 600A in the second direction is partially out of the ditch 212A while each of the opposite ends 615 is held by the housing 200A so that each of the opposite ends 615 bites the housing 200A. Specifically, in this state, each of the protrusions 614 of the connection portion 610A of the second busbar 600A is partially out of the ditch 212A while each of the protrusions 614 is held by the housing 200A so that each of the protrusions 614 bites the housing 200A. Additionally, In this state, the additional connection portion 630 of the second busbar 600A and the third busbar 850 are brought into close contact with each other in the third direction and the clearance CLA is absorbed.

As described above, the structure 10A of the present embodiment can reduce positional variation of the connection portion 610A of the second busbar 600A by using the resilient deformation of the coupling portion 330 of the terminal 300A when the structure 10A attached to the housing 800 is connected to the third busbars 850. That is, under the fastened state, the structure 10A can reduce the positional variation of the connection portion 610A of the second busbar 600A by using the resilient deformation of the coupling portion 330 of the terminal 300A. As described above, upon the reduction of the positional variation, the connection portion 610A of the second busbar 600A, which was positioned in the ditch 212A of the housing 200A, is partially out of the ditch 212A while the connection portion 610A is held by the housing 200A so that the connection portion 610A bites the housing 200A. Accordingly, the connection portion 610A of the second busbar 600A is hardly moved. Thus, even if the structure 10A of the present embodiment is used in a highly vibrational environment, the structure 10A of the present embodiment can prevent noise generation and can reduce possibility of damaging the second busbars 600A and the terminals 300A.

In the aforementioned attaching method, the second busbar 600A is screwed to the second connecting portion 320A of the terminal 300A of the relay structure 100A and then the second busbar 600A is screwed to the third busbar 850. However, the present invention is not limited thereto. Specifically, the order of their attachment may be modified as follows: the second busbar 600A is screwed to the third busbar 850 and then the second busbar 600A is screwed to the second connecting portion 320A of the terminal 300A of the relay structure 100A. The structure 10A can also have the same effect as the aforementioned effect even if the order of their attachment is modified as described above. When the second busbar 600A is screwed to the second connecting portion 320A in this case, each of the opposite ends 615 of the connection portion 610A of the second busbar 600A in the second direction is partially out of the ditch 212A and bites the housing 200A. Specifically, when the second busbar 600A is screwed to the second connecting portion 320A in this case, each of the protrusions 614 of the connection portion 610A of the second busbar 600A is partially out of the ditch 212A and bites the housing 200A.

In the aforementioned attaching method, the second busbars 600A are screwed to the relay structure 100A and then the relay structure 100A is attached on the housing 800. However, the present invention is not limited thereto. Specifically, the order of their attachment may be modified as follows: the relay structure 100A is attached on the housing 800 and then the second busbars 600A are screwed to the relay structure 100A. The structure 10A can also have the same effect as the aforementioned effect even if the order of their attachment is modified as described above.

As described above, each of the opposite ends 325A of the second connecting portion 320A of each of the terminals 300A in the second direction is positioned below the corresponding ditch 212A of the corresponding pair of the housing 200A in the up-down direction under the state where the relay structure 100A is connected to none of the second busbars 600A. However, the present invention is not limited thereto. Specifically, each of the opposite ends 325A of the second connecting portion 320A of each of the terminals 300A in the second direction may be positioned above the corresponding ditch 212A of the corresponding pair of the housing 200A in the up-down direction under the state where the relay structure 100A is connected to none of the second busbars 600A. In other words, each of the opposite ends 325A of the second connecting portion 320A of each of the terminals 300A in the second direction may be positioned above the corresponding ditch 212A of the corresponding pair of the housing 200A in the up-down direction when the relay structure 100A is viewed alone. Considering easy connection of the connection portion 610A of the second busbar 600A to the second connecting portion 320A of the relay structure 100A, the present embodiment is more preferable.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A structure comprising a fastening member, a first busbar, a second busbar and a relay structure, wherein:
the fastening member has a shaft portion;
the second busbar is provided with a connection portion;
the connection portion of the second busbar is provided with a hole portion;
the relay structure carries out relay between the first busbar and the second busbar;
the relay structure comprises a terminal and a housing;
the housing holds the terminal;
the housing is formed with at least one ditch;
the at least one ditch extends along a first direction and is recessed in a second direction perpendicular to the first direction;
the terminal has a first connecting portion, a second connecting portion and a coupling portion;
the coupling portion is resiliently deformable and couples the first connecting portion with the second connecting portion;
the first connecting portion is connected to the first busbar;
the second connecting portion is provided with a piercing hole;
the fastening member is in a fastened state where the fastening member is fastened;
under the fastened state, the shaft portion passes through both the hole portion and the piercing hole and extends in a shaft direction intersecting with both the first direction and the second direction;
the second connecting portion is connected to the connection portion of the second busbar under the fastened state; and
under the fastened state, one of the connection portion of the second busbar and the second connecting portion of the terminal is, at least in part, out of the at least one ditch and bites the housing.

2. The structure as recited in claim 1, wherein:
the second connecting portion of the terminal has ends in the second direction; and
under the fastened state, at least one of the ends of the second connecting portion of the terminal is, at least in part, out of the at least one ditch and bites the housing.

3. The structure as recited in claim 1, wherein:
the connection portion of the second busbar has ends in the second direction; and
under the fastened state, at least one of the ends of the connection portion of the second busbar is, at least in part, out of the at least one ditch and bites the housing.

4. The structure as recited in claim 1, wherein:
one of the connection portion of the second busbar and the second connecting portion of the terminal is provided with at least one protrusion which protrudes in the second direction; and
the at least one protrusion bites the housing under the fastened state.

5. A relay structure used in the structure as recited in claim 1, wherein:
the relay structure is configured to carry out relay between a first busbar and a second busbar;
the relay structure comprises a terminal and a housing;
the housing holds the terminal;
the housing is formed with at least one ditch;
the at least one ditch extends along a first direction and is recessed in a second direction perpendicular to the first direction;
the terminal has a first connecting portion, a second connecting portion and a coupling portion;
the coupling portion is resiliently deformable and couples the first connecting portion with the second connecting portion;
the first connecting portion is configured to be connected to the first busbar;
the second connecting portion is provided with a piercing hole;
the second connecting portion is configured to be connected to the second busbar; and
the piercing hole pierces the second connecting portion in a direction intersecting with both the first direction and the second direction.

6. The relay structure as recited in claim 5, wherein:
the second connecting portion has ends in the second direction; and
at least one of the ends of the second connecting portion is partially positioned in the at least one ditch of the housing.

7. The relay structure as recited in claim 6, wherein:
the housing has two side walls;
in the second direction, the two side walls are positioned apart from each other and face each other;
the at least one ditch includes two of the ditches;
the two ditches are formed on the two side walls, respectively;
the second connecting portion has opposite ends in the second direction; and
the opposite ends are partially positioned in the two ditches, respectively.

8. The relay structure as recited in claim 7, wherein:
the second connecting portion of the terminal is provided with two protrusions each protruding in the second direction; and
the protrusions are partially positioned in the two ditches, respectively.

9. The relay structure as recited in claim 5, wherein:
the second connecting portion of the terminal has ends in the second direction; and
at least one of the ends of the second connecting portion of the terminal is adjacent to the at least one ditch of the housing in a third direction perpendicular to both the first direction and the second direction.

10. The relay structure as recited in claim 9, wherein:
the housing has two side walls;
in the second direction, the two side walls are positioned apart from each other and face each other;
the at least one ditch includes two of the ditches;
the two ditches are formed on the two side walls, respectively;
the second connecting portion has opposite ends in the second direction; and
the opposite ends are adjacent to the two ditches, respectively, in the third direction.

11. The relay structure as recited in claim 5, wherein the coupling portion has an S-shaped cross-section in a plane perpendicular to the second direction.

12. The relay structure as recited in claim 5, wherein the at least one ditch has a tapered shape in the second direction.
